(19) United States
(12) Patent Application Publication
(10) Pub. No.: US 2025/0377032 A1
(43) Pub. Date: Dec. 11, 2025

(54) BUSHING MOUNT AND A MANUFACTURING METHOD THEREOF

(71) Applicants: HYUNDAI MOTOR COMPANY, Seoul (KR); KIA CORPORATION, Seoul (KR)

(72) Inventor: Seung Won Kim, Hwaseong-si (KR)

(73) Assignees: HYUNDAI MOTOR COMPANY, Seoul (KR); KIA CORPORATION, Seoul (KR)

(21) Appl. No.: 18/961,016

(22) Filed: Nov. 26, 2024

(30) Foreign Application Priority Data
Jun. 7, 2024 (KR) 10-2024-0074245

(51) Int. Cl. F16F 1/38

(52) U.S. Cl. CPC F16F 1/3842; F16F 2226/045

(57) ABSTRACT

Disclosed are a bushing mount and a manufacturing method thereof that may relieve residual stress of a rubber bushing molded on a middle pipe and increase durability. The manufacturing method of the bushing mount includes disposing the middle pipe coaxially with an expansion pipe, molding the rubber bushing on the middle pipe to be joined to an outer circumferential surface of the expansion pipe and surround the middle pipe, press-fitting the rubber bushing into an outer pipe, and press-fitting an inner pipe having a radius greater than a radius of the expansion pipe into the expansion pipe to expand the expansion pipe.

### CROSS-REFERENCE TO RELATED APPLICATION

This application claims under 35 U.S.C. § 119 (a) the benefit of and priority to

Korean Patent Application No. 10-2024-0074245, filed on Jun. 7, 2024, the entire contents of which are incorporated herein by reference.

### BACKGROUND

### (a) Technical Field

The present disclosure relates to a bushing mount and a manufacturing method thereof. More particularly, it relates to a manufacturing method of a bushing mount to relieve residual stress generated during molding of a rubber bushing and improve durability.

### (b) Background Art

As is known, electric vehicles are driven by motors. The motor is mounted on a vehicle body through a mount to isolate vibration transmitted to the vehicle body when the motor is driven.

Among types of mounts, there are a bushing rubber mount (hereinafter “bush mount”) including a rubber bushing vulcanized between an inner pipe and an outer pipe. The rubber bushing undergoes a process of cooling at room temperature after vulcanization. In this process, very large shrinkage of the rubber bushing occurs compared to the inner pipe and the outer pipe made of a metal, and as the rubber bushing shrinks, residual stress is generated inside the rubber bushing. Due to the residual stress, a pulling force is exerted between the rubber bushing and the inner pipe and between the rubber bushing and the outer pipe, and thus causes damage to the rubber bushing when the rubber bushing is stretched.

Therefore, conventionally, in order to relieve the residual stress generated inside the rubber bushing, a distance between the outer pipe and the inner pipe is reduced and the rubber bushing is compressed by swaging the outer pipe.

Further, the conventional rubber mount may be configured to use a working fluid or increase the axial characteristics of the rubber mount to isolate vibrations in more various frequency ranges. In this case, as shown in FIGS. 12 and 13, a middle pipe 2 formed of a metal is applied to the inside of rubber bushing 4. The rubber bushing 4 is vulcanized on the middle pipe 2, and the rubber bushing 4 and the middle pipe 2 are located between an outer pipe 3 and an inner pipe 1.

However, if the middle pipe 2 is located between the outer pipe 3 and the inner pipe 1, the residual stress in the rubber bushing 4 is not properly relieved, and thus durability of the rubber bushing 4 is reduced. The reason for this is that, when swaging the outer pipe 3, due to the middle pipe 2, only a rubber bushing portion (i.e., an outer rubber bushing portion) 4a between the outer pipe 3 and the middle pipe 2 is compressed and a rubber bushing portion (i.e., an inner rubber bushing portion) 4b between the middle pipe 2 and the inner pipe 1 may not be compressed. In addition, the outer rubber bushing portion 4a has a very small volume compared to the inner rubber bushing portion 4b. If the residual stress of the rubber bushing 4 is not relieved, the durability of the rubber bushing 4 is deteriorated and damage to the rubber bushing 4 is likely to occur when the rubber bushing 4 is stretched.

Further, the middle pipe 2 has openings 2a at the center thereof, as shown in FIG. 12. Thereby, when swaging the outer pipe 3, the middle pipe 2 does not receive force evenly and is bent, thereby causing a problem in which the middle pipe 2 protrudes to the outside of the outer pipe 3.

The above information disclosed in this Background section is provided only to enhance understanding of the background of the present disclosure and therefore it may contain information that does not form the prior art that is already known to a person of ordinary skill in the art.

### SUMMARY

The present disclosure has been made in an effort to solve the above-described problems associated with the prior art, and it is an object of the present disclosure to provide a bushing mount and a manufacturing method thereof that may relieve residual stress of a rubber bushing molded on a middle pipe and increase durability.

The objects of the present disclosure are not limited to the above-mentioned objects, and other objects not mentioned herein will be clearly understood by persons of ordinary skill in the art to which the present disclosure pertains (referred to as “those skilled in the art”) from the following description.

In one aspect of the present disclosure, a manufacturing method of a bushing

mount (“bushing mount”), includes: disposing a middle pipe coaxially with and outside of an expansion pipe, molding a rubber bushing on the middle pipe to be joined to an outer circumferential surface of the expansion pipe and surround the middle pipe, press-fitting the rubber bushing into an outer pipe, and press-fitting an inner pipe having a radius greater than a radius of the expansion pipe into the expansion pipe to expand the expansion pipe.

In an embodiment, the manufacturing method may further include swaging the outer pipe configured such that the rubber bushing is press-fitted thereinto.

In another embodiment, the expansion pipe may include a plurality of first pipe portions and a plurality of second pipe portions alternately disposed in a circumferential direction thereof, and a first distance from a circumferential center of each of the first pipe portions to a radial center of the outer pipe may be smaller than a second distance from a circumferential center of each of the second pipe portions to the radial center of the outer pipe.

In still another embodiment, the radius of the inner pipe may be greater than the first distance, and may be smaller than the second distance.

In yet another embodiment, the rubber bushing may have a plurality of voids configured to extend in an axial direction thereof, and the plurality of voids may be located on the same line as the second pipe portions in a radial direction of the outer pipe.

In still yet another embodiment, a wedge portion may be provided at one end of the inner pipe, and the wedge portion may be formed to be tapered based on an axial center of the inner pipe. A minimum radius of the wedge portion may be smaller than the first distance.

In another aspect, the present disclosure provides a bushing mount manufactured by the above manufacturing method.

Other aspects and embodiments of the disclosure are discussed below.

The above and other features of the disclosure are discussed infra.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 is an exploded perspective view showing a bushing mount according to one embodiment of the present disclosure;

FIG. 2 is a cut-away perspective view showing the bushing mount according to one embodiment of the present disclosure;

FIG. 3 is a cross-sectional view showing the bushing mount according to one embodiment of the present disclosure;

FIGS. 4 to 6 are views showing a manufacturing process of the bushing mount according to one embodiment of the present disclosure;

FIGS. 7 and 8 are views showing some operations of a manufacturing process of a bushing mount according to another embodiment of the present disclosure;

FIG. 9 is a combined perspective view showing a bushing mount according to yet another embodiment of the present disclosure;

FIG. 10 is a combined perspective view showing a portion of the bushing mount according to yet another embodiment of the present disclosure;

FIG. 11 is a perspective view showing an inner pipe of the bushing mount

according to yet another embodiment of the present disclosure;

FIG. 12 is a view showing a conventional bushing mount; and

FIG. 13 is a view showing the conventional bushing mount before and after swaging an outer pipe.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, should be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure are described with reference to the accompanying drawings. Matters included in the accompanying drawings are schematic to easily explain the embodiments of the present disclosure, and may differ from actually implemented forms.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When a component, device, element, or the like of the present disclosure is described as having a purpose or performing an operation, function, or the like, the component, device, or element should be considered herein as being “configured to” meet that purpose or to perform that operation or function.

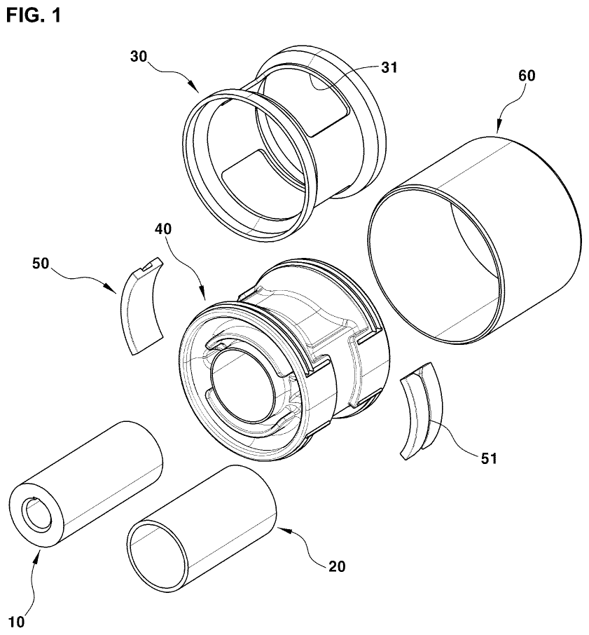

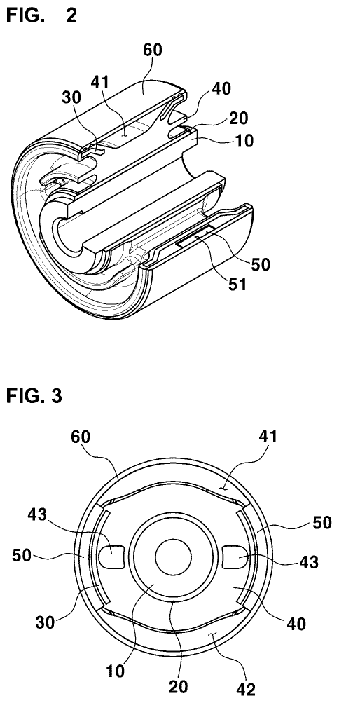

As shown in FIGS. 1 to 3, a bushing mount according to one embodiment of the present disclosure includes an inner pipe 10, an expansion pipe 20, a middle pipe 30, a rubber bushing 40, damping pads 50, and an outer pipe 60.

The inner pipe 10 has a hollow cylindrical structure, and may be coupled to a vibrating body through a separate fastener. For example, the vibrating body may be a motor to drive an electric vehicle. The inner pipe 10 is coupled to the inside of the expansion pipe 20 by press-fitting.

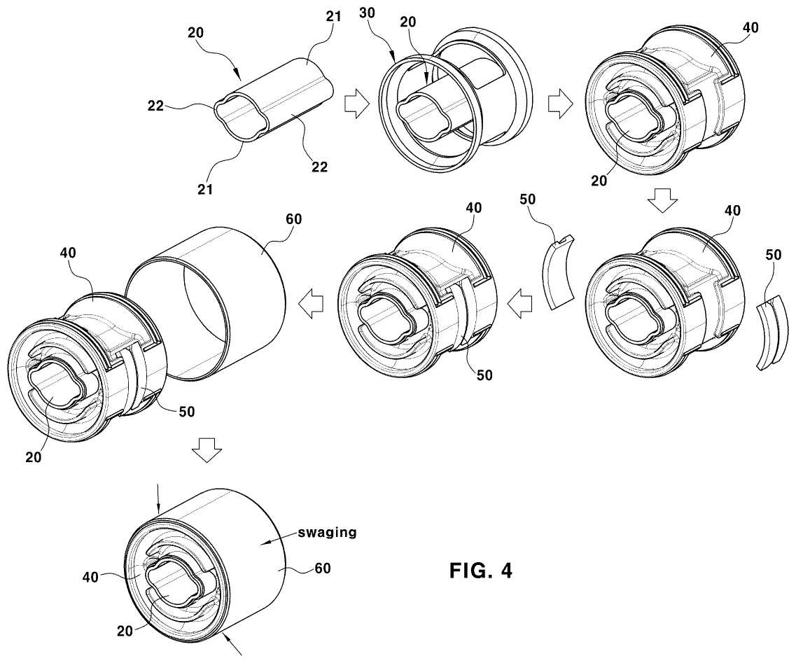

Referring to FIGS. 4 to 6, the expansion pipe 20 has an approximately hollow elliptical cross-sectional structure before being coupled to the inner pipe 10, and has a hollow cylindrical structure after being coupled to the inner pipe 10.

Before being coupled to the inner pipe 10, the expansion pipe 20 has a structure including first pipe portions 21 and second pipe portions 22. The first pipe portions 21 and the second pipe portions 22 are alternately arranged in the circumferential direction of the expansion pipe 20. Here, the first pipe portions 21 are arranged to face each other, and the second pipe portions 22 are arranged to face each other.

In addition, the first pipe portions 21 are configured to have a smaller curvature than the curvature of the second pipe portions 22. Accordingly, referring to FIG. 6, a distance R1 (i.e., a first distance) from the circumferential center of each of the first pipe portions 21 to a mount center is less than a distance R2 (i.e., a second distance) from the circumferential center of each of the second pipe portions 22 to the mount center. Further, the second pipe portions 22 protrude more convexly outwards in the radial direction of the expansion pipe 20 compared to the first pipe portions 21. The mount center is the same as the centers of the inner pipe 10, the rubber bushing 40, and the outer pipe 60 in the radial direction.

The first distance R1 is less than an outer radius value of the inner pipe 10, and the second distance R2 exceeds the outer radius value of the inner pipe 10. The first distance R1 may be the minimum radius of the expansion pipe 20, and the second distance R2 may be the maximum radius of the expansion pipe 20. In the present disclosure, the first distance R1 may be described as the inner radius of the first pipe portions 21, and the second distance R2 may be described as the inner radius of the second pipe portions 22. The outer diameter of the inner pipe 10 is a distance from the mount center to the outer circumferential surface of the inner pipe 10, and the inner diameter of the first pipe portions 21 is a distance from the mount center to the inner circumferential surfaces of the first pipe portions 21.

As the inner pipe 10 is assembled with the expansion pipe 20 through press-fitting, the minimum radius of the expansion pipe 20 is increased and the maximum radius of the expansion pipe 20 is decreased. At this time, as the expansion pipe 20 is expanded and deformed outwards in the radial direction, the rubber bushing 40 shrinks and is compressed, and the inner diameter of the rubber bushing 40 is increased. Further, by forcibly press-fitting the inner pipe 10 into the expansion pipe 20, the coupling force between the expansion pipe 20 and the inner pipe 10 may be secured, and separation of the inner pipe 10 from the expansion pipe 20 may be avoided or prevented.

The middle pipe 30 is disposed coaxially with the inner pipe 10 and the expansion pipe 20. The middle pipe 30 has a pair of openings 31 located opposite each other. The openings 31 are filled with rubber resin when the rubber bushing 40 is vulcanized.

The rubber bushing 40 is molded on the surface of the middle pipe 30 by vulcanization to surround the middle pipe 30. Here, the rubber bushing 40 is molded to the outer circumferential surface of the expansion pipe 20 and joined to the outer circumferential surface of the expansion pipe 20.

As shown in FIGS. 1 to 3, the rubber bushing 40 is molded into a structure with an upper chamber 41 and a lower chamber 42. The upper chamber 41 is provided on the upper portion of the rubber bushing 40, and the lower chamber 42 is provided on the lower portion of the rubber bushing 40. The rubber bushing 40 is press-fitted into the outer pipe 60 and is positioned between the expansion pipe 20 and the outer pipe 60. The upper chamber 41 and the lower chamber 42 are sealed by the outer pipe 60.

The outer pipe 60 is formed to have a hollow cylindrical structure and is installed in a structure on which the vibrating body is mounted. For example, the structure may be a vehicle body on which a motor is mounted, and the outer pipe 60 may be coupled to the vehicle body through a separate fastener.

Further, a pair of damping pads 50 is assembled on both side walls of the rubber bushing 40. The damping pads 50 are located between the upper chamber 41 and the lower chamber 42 in the circumferential direction of the rubber bushing 40. The damping pad 50 has a channel 51 to connect the upper chamber 41 and the lower chamber 42.

The channel 51 extends in the circumferential direction of the rubber bushing 40 and allows a working fluid or air to move between the upper chamber 41 and the lower chamber 42. The working fluid or air may damp vibration of the vibrating body while moving between the upper chamber 41 and the lower chamber 42 through the channel 51.

Further, the rubber bushing 40 has a pair of voids 43 extending in the axial direction of the rubber bushing 40. Referring to FIGS. 4 to 6, the voids 43 are located along the same line as the second pipe portions 22 in the radial direction of the rubber bushing 40 and the outer pipe 60.

The voids 43 may be disposed in the horizontal direction based on the state in which the mount of the present disclosure is mounted on the vehicle.

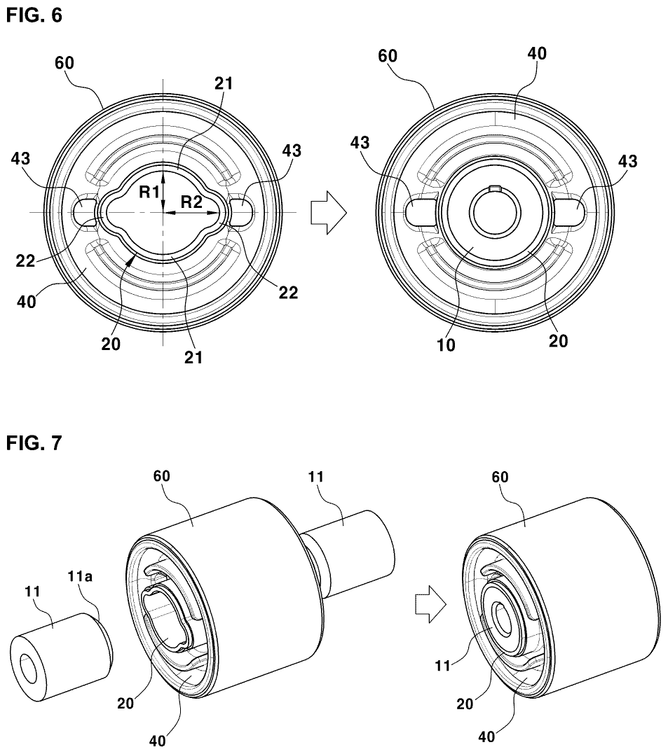

Referring to the embodiment shown in FIGS. 7 and 8, each of inner pipes 11 may have a wedge portion 11a at one end thereof in the axial direction. The wedge portion 11a is formed to be tapered based on the axial center of the inner pipe 11. Thereby, the outer diameter of the end of the inner pipe 11 is gradually decreased in the axial direction.

For easy entry into the expansion pipe 20 and expansion of the expansion pipe 20, the wedge portion 11a has a minimum outer diameter smaller than the first distance R1 and a maximum outer diameter greater than the first distance R1.

The wedge portion 11a is provided at at least one end of the inner pipe 11, thereby facilitating the press-fitting process of the inner pipe 11 and the expansion operation of the expansion pipe 20.

The bushing mount according to the present disclosure configured as described above may be assembled and manufactured through the following process.

As shown in FIG. 4, first, the middle pipe 30 is disposed outside the expansion pipe 20 in the radial direction. At this time, the middle pipe 30 is disposed coaxially with the expansion pipe 20.

Thereafter, the rubber bushing 40 for vibration isolation of the vibrating body is molded on the middle pipe 30 through a vulcanization process. The rubber bushing 40 is molded on the surface of the middle pipe 30 to surround the entirety of the middle pipe 30. Here, the rubber bushing 40 is molded to the outer circumferential surface of the expansion pipe 20 and joined to the outer circumferential surface of the expansion pipe 20.

The rubber bushing 40 is molded into a shape with the upper chamber 41, the lower chamber 42, and the voids 43. Further, the rubber bushing 40 has a recessed structure for the assembly of the damping pads 50. During the vulcanization process, a vulcanization mold for molding the rubber bushing 40 may be used.

Thereafter, the damping pads 50 are inserted into both side walls of the rubber bushing 40 to be assembled with the rubber bushing 40, and then the rubber bushing 40 is press-fitted into the outer pipe 60.

The dimensions of the outer pipe 60, into which the rubber bushing 40 has been press-fitted, is reduced through swaging, and thereby, the diameter of the outer pipe 60 is reduced. In the process of swaging the outer pipe 60, the rubber bushing 40 is compressed, and the outer diameter of the rubber bushing 40 is reduced. When swaging the outer pipe 60, the upper chamber 41 and the lower chamber 42 of the rubber bushing 40 and the channels 51 of the damping pads 50 are sealed by the inner circumferential surface of the outer pipe 60.

When swaging the outer pipe 60, only residual stress in an area between the outer pipe 60 and the middle pipe 30 among residual stress remaining in the rubber bushing 40 needs to be removed, and therefore, compared to the conventional case, external force applied to the outer pipe 60 is relatively reduced and the middle pipe 30 is not deformed during the swaging process. The reason for this is because residual stress remaining in the remaining area of the rubber bushing 40 (i.e., an area between the expansion pipe 20 and the middle pipe 30) may be removed through the process of press-fitting the inner pipe 10 into the expansion pipe 20.

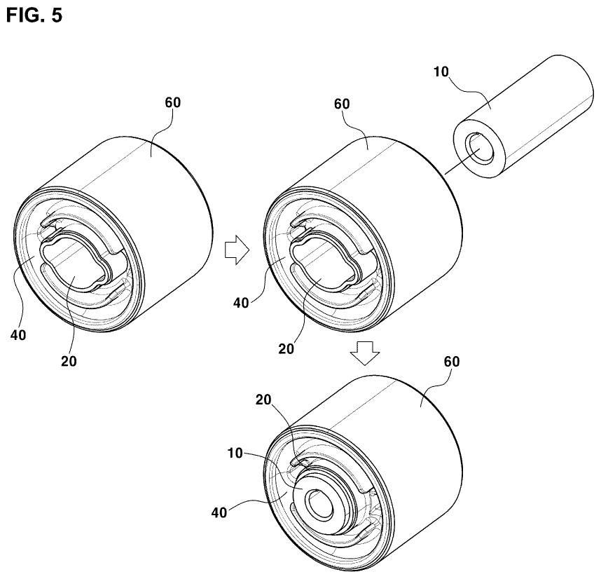

When the swaging process of the outer pipe 60 has been completed, the inner pipe 10 is press-fitted into the expansion pipe 20, as shown in FIGS. 5 and 6.

The expansion pipe 20 has the second pipe portions 22 having a greater radius than the radius of the inner pipe 10, thereby being capable of securing a free space for expansion and thus improving an expansion limit.

Since the inner pipe 10 has a greater radius than the minimum radius of the expansion pipe 20 (i.e., the inner radius of the first pipe portions 21), as the inner pipe 10 is press-fitted into the expansion pipe 20, the first pipe portions 21 of the expansion pipe 20 expand outwards. Here, the second pipe portions 22 of the expansion pipe 20 are pulled inwards.

Accordingly, the minimum radius of the expansion pipe 20 is increased, and the maximum radius of the expansion pipe 20 (i.e., the inner radius of the second pipe portions 22) is decreased. Therefore, the radius of the expansion pipe 20 is uniformized and thus has the same cylindrical structure, i.e., circular cross-section, as the inner pipe 10, and the upper portion and the lower portion of the rubber bushing 40 are mainly compressed.

The rubber bushing 40 has the voids 43 to facilitate press-fitting of the inner pipe 10 and expansion of the expansion pipe 20. The reason for this is because, when the inner pipe 10 press-fitted into the expansion pipe 20, the voids 43 expand inward in the radial direction, and absorb deformation of the side walls of the rubber bushing 40.

In addition, the voids 43 are located along the same line as the second pipe portions 22, thereby preventing the side walls of the rubber bushing 40 from excessively expanding.

Further, the voids 43 are not provided in the upper and lower portions of the rubber bushing 40 and are provided only in the side walls of the rubber bushing 40, and are thus adjacent to the first pipe portions 21 of the expansion pipe 20, and thereby, when the inner pipe 10 is press-fitted into the expansion pipe 20, the upper and lower portions of the rubber bushing 40 are mainly compressed.

Further, as shown in FIGS. 7 and 8, if a pair of inner pipes 11 having the wedge portions 11a is used, entry of the inner pipes 11 into the expansion pipe 20 becomes easier. The pair of inner pipes 11 is press-fitted into the expansion pipe 20 until the ends thereof come into contact with each other, and thus, the expansion pipe 20 is uniformly expanded as a whole.

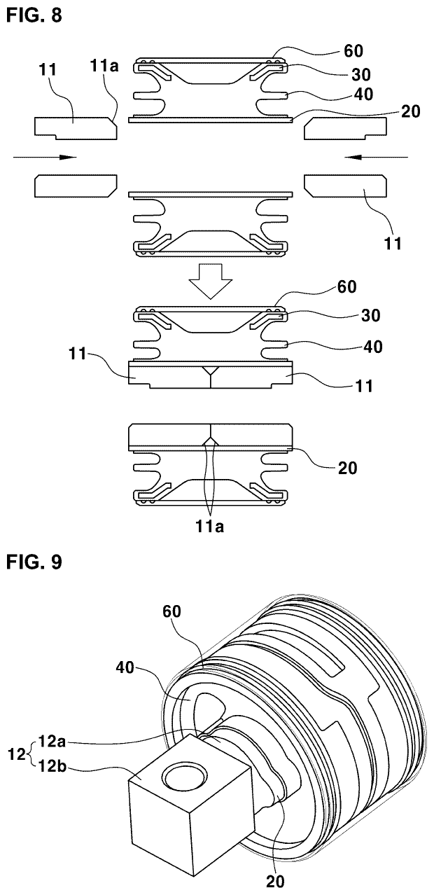

In addition, as seen from the embodiment shown in FIGS. 9 to 11, a non-hollow inner pipe 12 may be applied to the bushing mount of the present disclosure. Here, the non-hollow inner pipe 12 may be called a “core” in other words.

The non-hollow inner pipe 12 is formed as a solid cylindrical structure, and coupling portion 12b and a wedge portion 12c are provided at both ends of the non-hollow inner pipe 12 in the axial direction.

Specifically, the non-hollow inner pipe 12 includes a pipe main body 12a having a non-hollow cylindrical structure, and the coupling portion 12b and the wedge portion 12c provided at both ends of the pipe main body 12a.

The pipe main body 12a has a greater radius than the radius of the expansion pipe 20. Specifically, the radius of the pipe main body 12a is greater than the first distance R1 of the expansion pipe 20, and is less than the second distance R2 of the expansion pipe 20.

The coupling portion 12b provided at one end of the pipe main body 12a has a coupling hole 12d which completely penetrates the center of the end of the pipe main body 12a, and may be coupled to the vibrating body through the coupling hole 12d. In other words, the non-hollow inner pipe 12 may be coupled to the vibrating body in the vehicle through the coupling portion 12b. Further, the coupling portion 12b may be formed as a regular hexahedron structure having a width equal to or similar to the diameter of the pipe main body 12a.

The wedge portion 12c provided at the other end of the pipe main body 12a is formed to be tapered based on the axial centers of the non-hollow inner pipe 12 and the pipe main body 12a. The wedge portion 12c has a minimum outer diameter smaller than the first distance R1, and a maximum outer diameter greater than the first distance R1.

The pipe main body 12a may easily enter the expansion pipe 20 through the wedge portion 12c.

The non-hollow inner pipe 12 is coupled to the expansion pipe 20 by press-fitting the pipe main body 12a into the expansion pipe 20. At this time, the pipe main body 12a is press-fitted into the expansion pipe 20 until one end of the pipe main body 12a is located on the same plane as a corresponding end of the expansion pipe 20. Thereby, the position of the non-hollow inner pipe 12 may be set. The non-hollow inner pipe 12 may be formed of aluminum or steel.

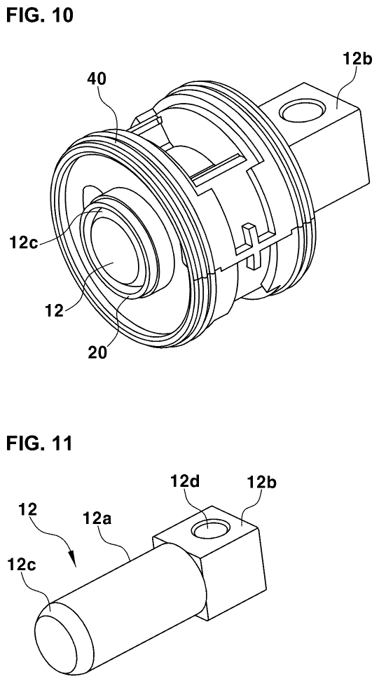

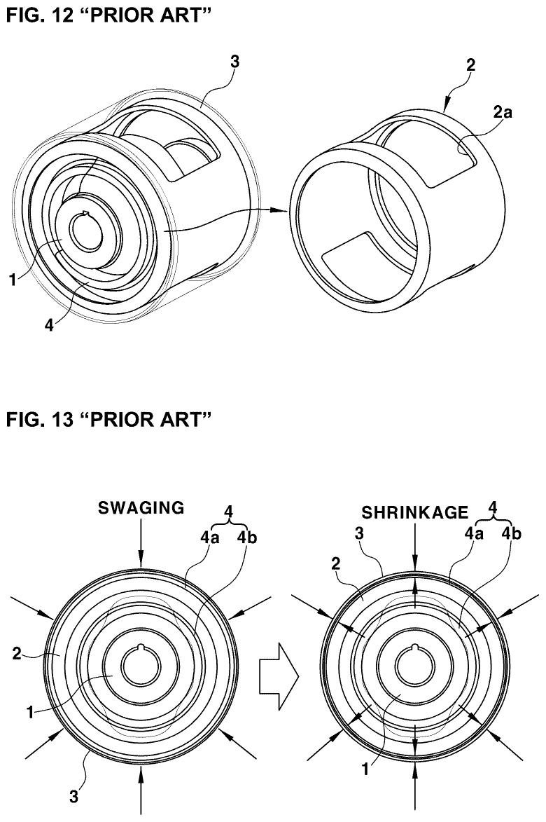

In addition, FIG. 9 shows the expansion pipe 20 in an undeformed state, and actually, as shown in FIG. 10, as the non-hollow inner pipe 12 is forcibly inserted into the expansion pipe 20, the expansion pipe 20 has a cylindrical structure.

As is apparent from the above description, the present disclosure provides a bushing mount and a manufacturing process thereof that may relieve residual stress of a rubber bushing in a process of press-fitting an inner pipe into an expansion pipe, and may thus improve durability of the mount. Here, the durability of the mount may be improved to the same level as a rubber mount to which a middle pipe and a working fluid are not applied.

The effects of the present disclosure are not limited to the above-mentioned effects, and other effects not mentioned herein will be clearly understood by those skilled in the art from the above description.

As the embodiments of the present disclosure have been described in detail above, the terms used in the above description and claims should not be construed as being limited to ordinary or dictionary meanings thereof. In addition, the scope of the present disclosure is not limited to the above-described embodiments, and it will be appreciated by those skilled in the art that changes may be made in these embodiments without departing from the principles and spirit of the disclosure, the scope of which is defined in the appended claims and their equivalents.

What is claimed is:

1. A manufacturing method of a bushing mount, comprising:
disposing a middle pipe coaxially with and outside of an expansion pipe;
molding a rubber bushing on the middle pipe to be joined to an outer circumferential surface of the expansion pipe and surround the middle pipe;
press-fitting the rubber bushing into an outer pipe; and
press-fitting an inner pipe having a radius greater than a radius of the expansion pipe into the expansion pipe to expand the expansion pipe.

2. The manufacturing method of claim 1, further comprising swaging the outer pipe configured such that the rubber bushing is press-fitted thereinto.

3. The manufacturing method of claim 1, wherein the expansion pipe comprises a plurality of first pipe portions and a plurality of second pipe portions alternately disposed in a circumferential direction thereof,
wherein a first distance from a circumferential center of each of the plurality of first pipe portions to a radial center of the outer pipe is smaller than a second distance from a circumferential center of each of the plurality of second pipe portions to the radial center of the outer pipe.

4. The manufacturing method of claim 3, wherein the radius of the inner pipe is greater than the first distance.

5. The manufacturing method of claim 3, wherein the radius of the inner pipe is smaller than the second distance.

6. The manufacturing method of claim 3, wherein the rubber bushing has a plurality of voids configured to extend in an axial direction thereof, and the plurality of voids is located on the same line as the plurality of second pipe portions in a radial direction of the outer pipe.

7. The manufacturing method of claim 3, wherein a wedge portion is provided at one end of the inner pipe, and the wedge portion is formed to be tapered based on an axial center of the inner pipe.

8. The manufacturing method of claim 7, wherein a minimum radius of the wedge portion is smaller than the first distance.

9. A bushing mount, comprising:
an expansion pipe;
an inner pipe configured to have a radius greater than a radius of the expansion pipe and press-fitted into the expansion pipe;
a middle pipe arranged coaxially with the expansion pipe and disposed outside the expansion pipe; and
a rubber bushing molded to surround the middle pipe and press-fitted into an outer pipe.

10. The bushing mount of claim 9, wherein the inner pipe has a hollow cylindrical structure or a non-hollow cylindrical structure.
